(19) United States
(12) Patent Application Publication
(10) Pub. No.: US 2026/0060874 A1
(43) Pub. Date: Mar. 5, 2026

(54) SEMI PASSIVE JOINT EXOSKELETON

(71) Applicants: David ZARROUK, Petach Tikva (IL); Raziel RIEMER, Lehavim (IL); Alon SADE, Sderot (IL)

(72) Inventors: David ZARROUK, Petach Tikva (IL); Raziel RIEMER, Lehavim (IL); Alon SADE, Sderot (IL)

(21) Appl. No.: 19/315,904

(22) Filed: Sep. 2, 2025

Related U.S. Application Data
(60) Provisional application No. 63/689,743, filed on Sep. 1, 2024.

(51) Int. Cl. A61H 3/00; A61H 1/02

(52) U.S. Cl. CPC A61H 3/00; A61H 1/024; A61H 2003/007; A61H 2201/1207; A61H 2201/1253; A61H 2201/1445; A61H 2201/1642; A61H 2201/5007; A61H 2201/5069; A61H 2230/625

(57) ABSTRACT

An exoskeleton for assisting a user to run/walk is provided. The exoskeleton assembly comprises a thigh link and a shank link for attaching to the user, an arm link pivotally articulated thereto, a spring connected to the thigh link and arm link, a transmission configured to control movement between the arm and the shank links, one or more sensors, and a controller. The transmission has a clutch, operable by the controller, configured to selectively engage/disengage the shank link with the spring. The controller is configured, in response to indications received from the one or more sensors, to engage the clutch to store the user's knee energy in the spring or to provide stored energy from the spring to the user's knee, and to disengage the clutch to prevent the exoskeleton from interfering with the user's knee motion.

### CROSS REFERENCE TO RELATED APPLICATIONS

This application claims the benefit of priority of U.S. Provisional Patent Application No. 63/689,743, filed Sep. 1, 2025, the contents of which are all incorporated herein by reference in their entirety.

### TECHNICAL FIELD

The present disclosure relates generally to systems for assisting a user during running and walking, and in transitioning between sitting and standing. In particular, the presently disclosed subject matter relates to such systems comprising exoskeleton assemblies.

### BACKGROUND

Electro-mechanical wearable exoskeletons are designed to assist human motion and mobility in a number of contexts. Exoskeletons are used to increase weight-bearing capacity in individuals with disabilities, to reduce energy expenditure when walking and running, to harvest energy while walking, to increase jump height, etc.

Exoskeletons are tailored for specific anatomical regions, such as the upper limbs, lower limbs, and/or the back. They can be categorized as active or passive. Active exoskeletons employ actuators with controls to assist wearer movements, thereby affording adjustable support (e.g., moment profiles). Nonetheless, reliance on actuators and external power sources is often associated with high cost, bulkiness (both weight and size), limited battery life. Passive exoskeletons use mechanical components such as springs and dampers to provide assistance without external power input. This typically makes them lightweight and energy-efficient and hence highly suitable for cases of prolonged use. However, passive exoskeletons are typically tailored for a specific task (e.g., walking at a given speed).

### SUMMARY

Aspects of the disclosure, according to some embodiments thereof, relate to a semi-passive joint (e.g. knee, ankle, hip, etc.) exoskeleton assembly for providing assistance for a user while running/walking and during transitioning between sitting and standing positions. Some embodiments relate to an energy-efficient clutch mechanism activated by a motor which engages and disengages a spring with precise timing thereby supporting/assisting a user's leg during running/walking, and in transitioning between sitting and standing positions.

It is noted that, while the herein disclosed semi-passive exoskeleton assembly is specifically designed and exemplified for a knee, a similar approach/mechanism may be adapted for use with other joints, for upper or lower extremities, such as but not limited to, an ankle, a hip, shoulder, etc., in accordance with some embodiments. Knee exoskeletons are wearable devices designed to support and enhance knee joint function. They assist users by providing additional strength and stability, reducing the burden on the knee joint, and improving mobility for various populations, including the elderly, individuals with musculoskeletal disorders, and those undergoing rehabilitation.

The semi-passive knee exoskeleton assembly according to the presently disclosed subject matter may be provided without a heavy actuator. Moreover, it may have a lightweight design/construction, ergonomic comfort, cost-effectiveness, and minimal actuation, while efficiently utilizing energy.

In addition, the semi-passive knee exoskeleton assembly according to the presently disclosed subject matter combines passive elements with an active controller, offering a balanced approach to movement assistance. It may provide enhanced support by integrating mechanical components with limited actuation controllability, increasing the precision and adaptability of movement assistance compared to a fully passive system. This hybrid assembly improves energy efficiency by storing and releasing mechanical energy while using minimal power for adjustments, allowing for longer operational periods without frequent recharging.

According to some embodiments, the semi-passive knee exoskeleton assembly employs a transmission system integrating one or two motors (such as a miniature servomotor) which facilitate seamless transitioning between the engaged and disengaged spring modes, thereby assisting a user in running or walking at various speeds while adapting to changes in pace or sit to stand motions.

Furthermore, the semi-passive knee exoskeleton assembly may significantly reduce effort of the joint muscles while running, walking, sitting, and standing.

According to aspects of the presently disclosed subject matter, there is provided a semi-passive knee exoskeleton assembly configured to provide assistance to a user when running/walking, the semi-passive knee exoskeleton assembly comprising:
a thigh link associated with a thigh attachment configured to fit the user's thigh;
a shank link associated with a shank attachment configured to fit the user's shank;
an arm link pivotally articulated to the thigh link and to the shank link about a main knee shaft;
a spring connected to the thigh link at one end thereof, and to the arm link at an opposing end thereof;
a primary transmission carried within the arm link and being configured to control movement between the arm link and the shank link, the primary transmission comprising a primary clutch configured to be selectively engaged whereby the arm link pivots together with the shank link thereby engaging the shank link with the spring, and to be selectively disengaged whereby the arm link pivots independently of the shank link, the primary clutch comprising a primary motor configured to effect the engagement and disengagement;
one or more sensors, configured to provide signals indicative of the user's running/walking cycle phase; and
a controller configured to control, in real time, operation of the primary motor to engage and disengage the primary clutch;
the controller being configured, upon indication from the one or more sensors that the user has commenced a stance phase wherein the user's foot contacts the ground, to operate the primary motor to engage the clutch, such that during the bending of the knee energy is extracted from the user's knee negative power and is stored in the spring as it stretches,
the semi-passive knee exoskeleton assembly being configured to transfer energy stored in the spring to the user's knee as positive work when the user subsequently straightens the knee, thereby assisting the user's muscle in both movements, and
the controller being further configured, upon indication, from the one or more sensors that the user has commenced a swing phase, to operate the primary motor to disengage the clutch, thereby avoiding interference by the semi-passive knee exoskeleton assembly with the user's knee motion.

The thigh link may be configured to convert a tensile force generated by the spring into a moment applied to a knee.

The motor may be a servomotor.

The one or more sensors may comprise an inertial measurement unit sensor mounted on the shank of the user, on the shank attachment, or on the shank link.

The one or more sensors may comprise a potentiometer positioned on the main knee shaft and configured to measure a knee angle of the user.

The primary transmission may comprise a primary gear train, one end of the primary gear train meshing with a partial gear formed on an upper end of the shank link.

The semi-passive knee exoskeleton assembly may further comprise a real-time data recording module configured to record signals received from the one or more sensors.

The semi-passive knee exoskeleton assembly may further comprise a computer configured to assist in decision-making and sensor visualization.

The spring may be connected to the thigh link at one end thereof, and/or to the arm link at the opposing end thereof, via one or more cables.

The semi-passive knee exoskeleton assembly may further comprise a stopper incorporated in the thigh link, the stopper being configured to ensure that the knee does not bend in an undesired direction.

The semi-passive knee exoskeleton assembly may further comprise a control component configured to facilitate manual control over the clutch.

The ratio between the primary motor energy input and the user's energy output may be between about 1:20 and about 1:1000.

The semi-passive knee exoskeleton assembly may be further configured to provide assistance to a user in transitioning between a sitting position and a standing position, the semi-passive knee exoskeleton assembly further comprising:
a secondary transmission carried within the arm link and being configured to control movement between the arm link the thigh link, the secondary transmission comprising a secondary clutch configured to be selectively engaged whereby the arm link pivots together with the thigh link thereby engaging the thigh link with the spring, and to be selectively disengaged whereby the arm link pivots independently of the thigh link, the secondary clutch comprising a secondary motor configured to effect the engagement and disengagement;
the controller being configured, upon indication from the one or more sensors that the user is transitioning from a standing to a sitting position, to operate the primary motor to engage the primary clutch, such that during the bending of the knee energy is extracted from the user's knee negative power and is stored in the spring as it stretches,
the controller being further configured, upon indication from the one or more sensors that the user is sitting, to operate the primary motor to disengage the primary clutch, and to operate the secondary motor to engage the secondary clutch, and
the controller being further configured, upon indication from the one or more sensors that the user has commenced transitioning from a sitting to a standing position, to operate the secondary motor to disengage the secondary clutch, and to operate the primary motor to engage the primary clutch, whereby energy stored in the spring is transferred to the user's knee as positive work, thereby assisting the user in transitioning between sitting and standing positions.

The controller may be further configured, upon indication from the one or more sensors that the user is initiating a sitting position, to operate the secondary motor to engage the secondary clutch, such that during the bending of the knee energy is extracted from the user's knee negative power and is stored as the spring stretches;
the controller being further configured, upon indication from the one or more sensors that the user is in sitting position, to operate the secondary motor to engage the secondary clutch;
the controller being further configured, upon indication from the one or more sensors that the user is initiating a transition from a sitting to a standing position, to operate the secondary motor to disengage the secondary clutch, such that during straightening of the knee energy stored in the spring is transferred to the user's knee as positive work, thereby assisting the user's muscle in both movements.

According to aspects of the presently disclosed subject matter, there is provided a method for assisting running/walking of a user, the method comprising:
providing a semi-passive knee exoskeleton assembly as described above;
affixing the thigh and shank attachments to the user's thigh and shank, respectively;
receiving a first indication from the one or more sensors, that the user has commenced a stance phase wherein the user's foot contacts the ground;
in response to the first indication, operating the primary motor to engage the primary clutch, such that energy extracted from the user's knee negative power is stored in the spring as it stretches;
transferring energy stored in the spring as positive work when the user subsequently straightens the knee, thereby assisting the user's muscle movement; and
receiving a second indication from the one or more sensors that the user has commenced a swing phase; and
in response to the second indication, operating the primary motor to disengage the primary clutch, thereby avoiding interference by the semi-passive knee exoskeleton assembly with the user's knee motion.

The semi-passive knee exoskeleton assembly may further comprise a secondary transmission carried within the arm link and being configured to control movement between the arm link the thigh link, the secondary transmission comprising a secondary clutch configured to facilitate selectively engaging and disengaging the thigh link, the secondary clutch comprising a secondary motor configured to effect the engagement and disengagement, the method further comprising:
receiving a third indication from the one or more sensors that the user has commenced transitioning from a standing to a sitting position;
in response to the third indication, operating the primary motor to engage the primary clutch, such that during the bending of the knee energy is extracted from the user's knee negative power and is stored in the spring as it stretches;
receiving a fourth indication from the one or more sensors that the user is sitting;
in response to the fourth indication, operating the primary motor to disengage the primary clutch, and operating the secondary motor to engage the secondary clutch;
receiving a fifth upon indication from the one or more sensors that the user has commenced transitioning from a sitting to a standing position;
in response to the fifth indication, operating the secondary motor to disengage the secondary clutch, and operating the primary motor to engage the primary clutch, whereby energy stored in the spring is transferred to the user's knee as positive work, thereby assisting the user in transitioning between sitting and standing positions.

According to aspects of the presently disclosed subject matter, there is provided a semi-passive joint exoskeleton assembly configured to provide assistance to a user to move a limb, the semi-passive joint exoskeleton assembly comprising:
a first link associated with an upper attachment configured to fit a first part of the user's limb;
a second link associated with a lower attachment configured to fit a second part of the user's limb;
an arm link pivotally articulated to the first link and to the second link about a main joint shaft;
a spring connected to the first link at one end thereof, and to the arm link at an opposing end thereof;
a transmission carried within the arm link and being configured to control movement between the arm link and the first link, the transmission comprising a clutch configured to be selectively engaged whereby the arm link pivots together with the first link, and to be selectively and to be selectively disengaged whereby the arm link pivots independently of the first link, the clutch comprising a motor configured to effect the engagement and disengagement;
one or more sensors, configured to provide signals indicative of the user's movement of the limb; and
a controller configured to control, in real time, operation of the motor to engage and disengage the clutch.

### BRIEF DESCRIPTION OF THE FIGURES

Some embodiments of the disclosure are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the disclosure. For the sake of clarity, some objects depicted in the figures are not to scale. In the figures:

FIG. 1A is front perspective view of a semi-passive knee exoskeleton assembly according to the presently disclosed subject matter;

FIG. 1B is an exploded view of the semi-passive exoskeleton assembly illustrated in FIG. 1A;

FIG. 2 is a rear perspective view of an arm link of the semi-passive exoskeleton assembly illustrated in FIG. 1A;

FIG. 3 is an exploded front view of the arm link illustrated in FIG. 2;

FIGS. 4A and 4B are, respectively, left and right side views of a transmission of the semi-passive exoskeleton assembly illustrated in FIG. 1A;

FIGS. 5A and 5B are front view of the transmission illustrated in FIGS. 4A and 4B, in, respectively, engaged and disengaged positions of a clutch thereof;

FIGS. 6A through 6C schematically illustrate operation of the semi-passive knee exoskeleton assembly in different relative angular positions of its components;

FIG. 7 is a front perspective view of a secondary transmission, according to some embodiments of the semi-passive exoskeleton assembly illustrated in FIG. 1A;

FIGS. 8A and 8B illustrate the semi-passive exoskeleton assembly illustrated in FIG. 1A during running/walking in, respectively, initial and stance configurations;

FIGS. 9A and 9B illustrate the semi-passive exoskeleton assembly illustrated in FIG. 1A during running/walking in, respectively, initial and swing configurations;

FIGS. 10A and 10B illustrate the semi-passive exoskeleton assembly illustrated in FIG. 1A upon transitioning from a standing position to a sitting position, in, respectively, initial and sitting configurations;

FIGS. 11A and 11B illustrate the semi-passive exoskeleton assembly illustrated in FIG. 1A upon while the user is sitting, in, respectively, and engaged and disengaged position of the clutch;

FIGS. 12A and 12B illustrate the semi-passive exoskeleton assembly illustrated in FIG. 1A upon transitioning from a sitting position to a standing position, in, respectively, initial and standing configurations;

FIG. 13 schematically illustrates the semi-passive exoskeleton assembly illustrated in FIG. 1A during a running cycle;

FIG. 14 illustrates an example of an algorithm according to which a controller of the semi-passive exoskeleton assembly illustrated in FIG. 1A may operate;

FIG. 15 illustrates the relationship between the engaged/disengaged position of the clutch of the semi-passive exoskeleton assembly illustrated in FIG. 1A and the degree of freedom between am arm link and shank link thereof; and

FIGS. 16A and 16B are tabulated results of experiments performed using the semi-passive exoskeleton assembly illustrated in FIG. 1A.

### DETAILED DESCRIPTION

The principles, uses, and implementations of the teachings herein may be better understood with reference to the accompanying description and figures. Upon perusal of the description and figures present herein, one skilled in the art will be able to implement the teachings herein without undue effort or experimentation. In the figures, same reference numerals refer to same parts throughout.

The presently disclosed subject matter, in some embodiments thereof, relates to a system comprising a semi-passive knee exoskeleton with a spring and an actively controlled clutch to provide assistance when walking and running. When the user is running, the system extracts energy from the knee joint during a negative power thereof, stores it in the spring, and provides it to the knee joint during a positive power phase thereof. The control of the exoskeleton's operation during running uses a combination of a micro controller and an inertial measurement unit mounted on the shank of a user.

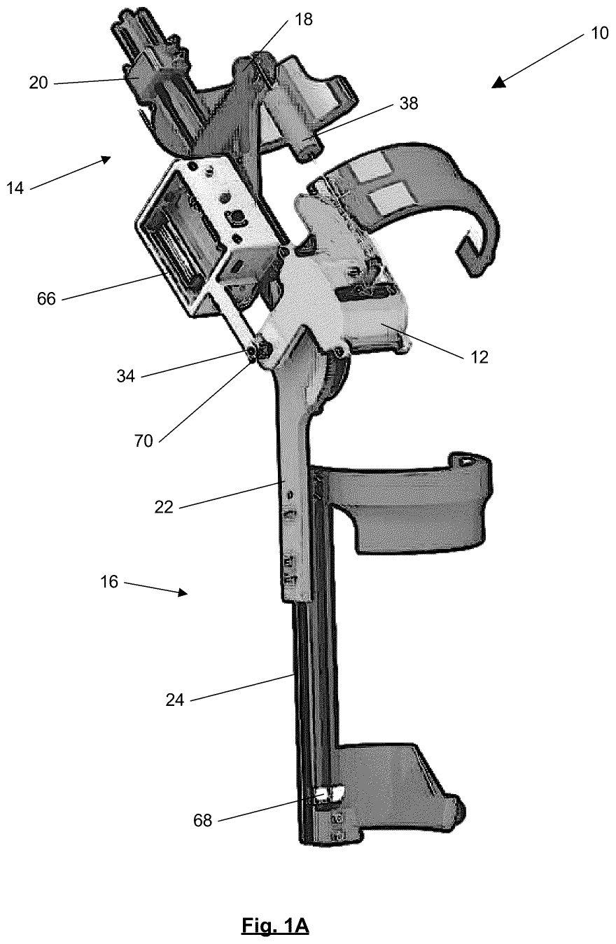

As illustrated in FIGS. 1A and 1B, there is provided a semi-passive knee exoskeleton assembly, which is generally indicated at 10, and which is configured to grip the leg of a user. According to some embodiments the semi-passive knee exoskeleton assembly 10 is configured to provide assistance to a user during walking and/or running. According to some embodiments, the semi-passive knee exoskeleton assembly 10 is configured to support/assist a user in transitioning between sitting and standing positions.

According to some embodiments, the semi-passive knee exoskeleton assembly 10 is configured to assist a user in running or walking at various speeds while adapting to changes in pace.

During running, the movement of each leg may be described as a running cycle (also referred to as a “gait cycle”), which comprises a stance phase and a swing phase. In the stance phase, the foot is in contact with the ground, and during most of this phase it remains relatively static. It starts when the foot is in contact with the ground and ends when the foot lifts off the ground (toe-off). The swing phase starts when the foot leaves the ground and ends with a new ground contact, thus completing one running cycle.

The semi-passive knee exoskeleton assembly 10 comprises an arm link 12, a thigh assembly 14, and a shank assembly 16. The thigh assembly 14 comprises a thigh link 18 and a thigh attachment 20 rigidly connected thereto and configured to securely grip the user's thigh, and the shank assembly 16 comprises a shank link 22 and a shank attachment 24 rigidly connected thereto and configured to securely grip the user's shank. The semi-passive knee exoskeleton assembly 10 may further comprise a controller configured to direct operation thereof.

The thigh attachment 20 comprises one or more thigh adapters 26 configured to receive therein the user's thigh to facilitate the gripping thereof, and a thigh profile 28 to which the thigh adapters are rigidly attached. Similarly, the shank attachment 24 comprises one or more shank adapters 30 configured to receive therein the user's shank to facilitate the gripping thereof, and a shank profile 32 to which the shank adapters are rigidly attached.

According to some embodiments, the arm link 12, the thigh link 18 and the shank link 22 are pivotally articulated each other via a main knee shaft 34, defining a pivot axis. The thigh link 18 may comprise a stopper 36, configured to restrict angular movement between the arm link 12 and the thigh link, ensuring a minimum angular separation therebetween.

The semi-passive knee exoskeleton assembly 10 further comprises a spring 38, attached at one end to the thigh link 18, for example to an arm 18a thereof, and at another end to the arm link 12. The spring 38 may be connected to other elements of the semi-passive knee exoskeleton assembly 10 directly, by a cable (including, but not limited to, a rope, wire, etc.), or in any other suitable way. References herein the specification and appended claims to the spring may be understood as referring to the spring or to the spring and the cable, etc., which connects it to other elements of the semi-passive knee exoskeleton assembly 10. The minimal angular separation ensured by the stopper 36 ensures the consistent presence of tension in the spring 38 throughout the entire running cycle.

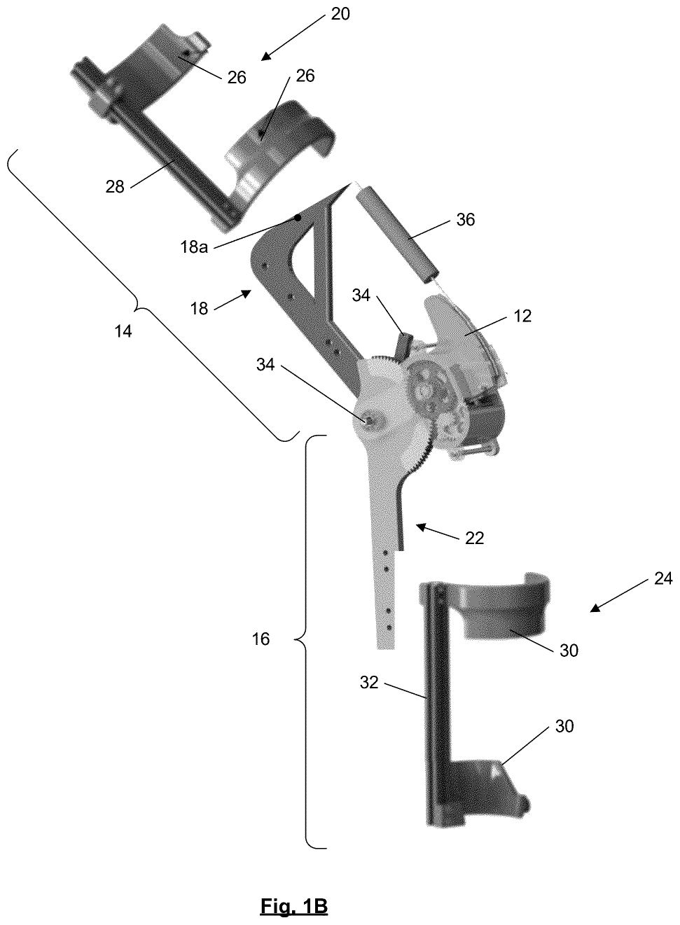

As seen in FIG. 2, the arm link 12 comprises an upper housing 40 and a shank-link arm 42a, a thigh-link arm 42b, and a center arm 42c projecting downwardly therefrom. Lowermost ends of the arms 42 are configured for accommodating the knee shaft 34 therethrough at the pivot axis. The upper housing 40 comprises a spring channel 44, e.g., being an open channel, formed thereon. The spring 38 is connected to the arm link 12 at one end of the spring channel 44, and is accommodated within the spring channel along its length. The spring channel 44 is curved to facilitate accommodating the spring 38 therewithin while the arm link 12 pivots.

As seen in FIG. 3, the arm link 12 further comprises a transmission socket 46 formed within the upper housing 40, e.g., between the shank-link arm 42a and the center arm 42c of the arm link 12. The transmission socket 46 comprises seats 48 formed within the shank-link and center arms 42a, 42c, the seats being configured to accommodate therein gears of a transmission, as will be described below.

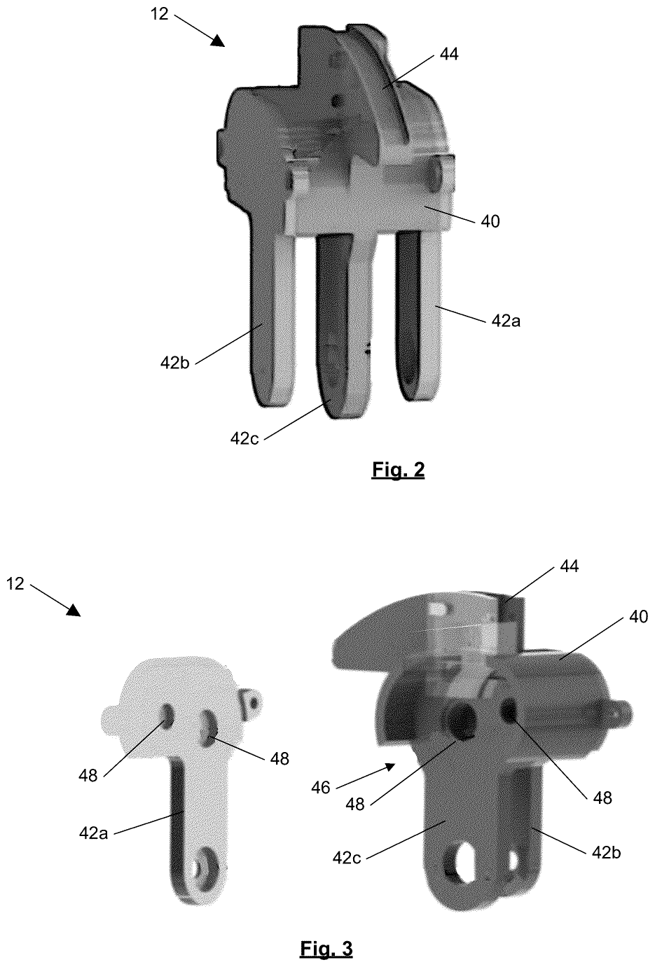

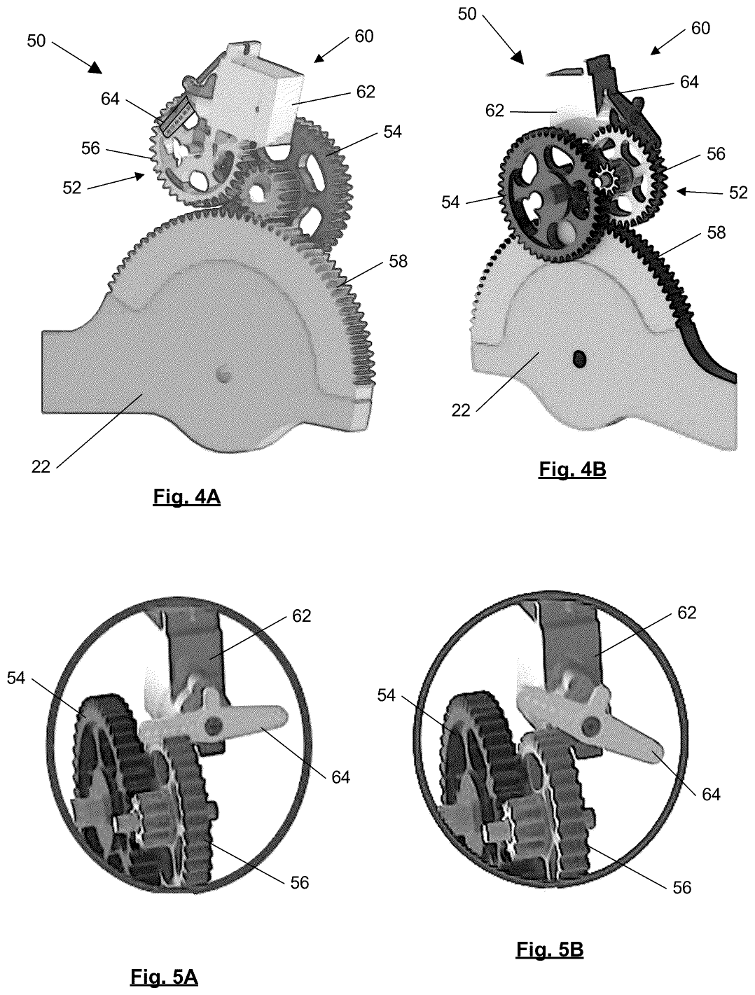

As illustrated in FIGS. 4A and 4B, the arm link 12 further comprises a transmission 50, configured to facilitate controlling movement between the arm link 12 (not shown in FIGS. 4A and 4B) and the shank link 22. The transmission 50 may comprise a gear train 52, comprising a first double gear 54 and a second double gear 56, accommodated within seats 48 formed in the transmission socket 46 described above with reference to and illustrated in FIG. 3. Moreover, an upper end of the shank link 22 comprises a partial gear 58 configured to mesh with the gear train 52, e.g., with the first double gear 54 thereof. The transmission 50 may be designed to achieve a reduction in moment of at least one order of magnitude.

According to some examples, the gear ratio of the first double gear 54 may be 45:16, and the gear ratio of the second double gear 56 may be 34:10, and the partial gear 58 of the shank link 22 is characterized by 100 teeth for the shank diameter. Accordingly, the transmission 50 may be configured, according to some examples, to provide a reduction in moment by a ratio of about 1:28.125.

While the gear train 52 of transmission 50 has been described above as comprising two double gears, in practice it may be provided according to any suitable design, for example comprising one or more simple gears, one or more double gears, one or more planetary gears, etc., without departing from the scope of the presently disclosed subject matter, mutatis mutandis. Furthermore, the gear train 52 may comprise any suitable number of gears.

The transmission 50 further comprises a clutch 60 configured to facilitate selectively engaging/disengaging the transmission 50 and the arm link 12, and thus the shank link 22 (the partial gear 58 of which meshed with the gear train 52 of the transmission) and the spring 38 (which is attached to the arm link 12) as will be described below, thereby influencing the system's dynamic behavior. The clutch 60 comprises one or more motors 60, e.g., a servomotor 62 such as a miniature servomotor, rigidly connected to the arm link 12, and a clutch lever 64 mounted on the shaft of the servomotor. As illustrated in FIGS. 5A and 5B, the servomotor 62 is configured to selectively bring the clutch 60 into an engaged mode by engaging the clutch lever 64 with the second double gear 56, and into a disengaged mode by disengaging the clutch lever from the second double gear. In the engaged mode of the clutch 60, the clutch lever 64 stops the motion of the second double gear, thereby eliminating the degree of freedom between the shank link 22 and the arm link 12, thus causing them to move together; accordingly, in the engaged mode of the clutch 60, movement of the shank which causes the knee to bend pulls the arm link 12, thereby stretching the spring 38. In the disengaged mode of the clutch 60, motion of the second double gear is unrestricted, thereby providing a degree of freedom between the shank link 22 and the arm link 12, allowing them to move separately; accordingly, in the disengaged mode of the clutch 60, movement of the shank has no effect on the spring 38. The reduction in moment provided by the transmission 50, for example as described above, reduces the moment required by the clutch 60 to stop the motion of the second double gear 56 in its engaged mode.

According to some examples, the arm link 12, including the transmission 50 and the clutch 60, has a total mass of about 800 g. The servomotor 62 may be a 13.4 g, 0.5 W servomotor which generates a moment of about 2 kg·cm (˜0.2 N·m) due to the transmission 50 providing a transmission ratio of about 1:28.

According to some embodiments, a factor of the semi-passive knee exoskeleton assembly 10 involves successfully engaging and disengaging the spring with precise timing. The mass of the semi-passive knee exoskeleton assembly 10 affects the effort required by the users. Accordingly, in accordance with some embodiments, the semi-passive knee exoskeleton assembly 10 may be characterized by lightweight construction, ergonomic comfort, cost-effectiveness, and/or minimal actuation with efficient energy utilization. According to some embodiments, the semi-passive knee exoskeleton assembly 10 has a mass not exceeding about 1650 grams, for example having a mass not exceeding about 1000 grams. Each possibility is a separate embodiment.

According to some embodiments, the primary function of the thigh link 18 is to convert the tensile force generated by the spring 38 into a moment applied to a knee joint to assist the knee muscles during motion. When the spring 38 is under tension, it applies a force on the thigh link arm 18a, resulting in a moment around the pivot axis centered on the knee. According to some embodiments, the restriction of the arm link's 12 angular movement by the stopper 36 may ensure a tension in the spring 38 of about 100 N to about 2,000 N, for example about 250 N to about 500 N.

According to some embodiments, the tensile force, converted into a moment applied to a knee to assist the knee muscles during motion, may be generated by an elastic material, such as but not limited to, a spring, a torsional spring, or any type of an elastic material capable of storing energy and subsequently releasing it. Each possibility is a separate embodiment. Accordingly, the term “spring” as used herein encompasses any suitable clastic material capable of storing energy and subsequently releasing it. According to some examples, the spring 38 is made of rubber tubing, for example as is known in the art. To stretch the spring, a transmission mechanism in the arm link is connected to teeth of the shank link. When the clutch 60 is in its engaged position, the degree of freedom between the arm link and the shank link is eliminated. This allows leg movement while simultaneously elongating the spring.

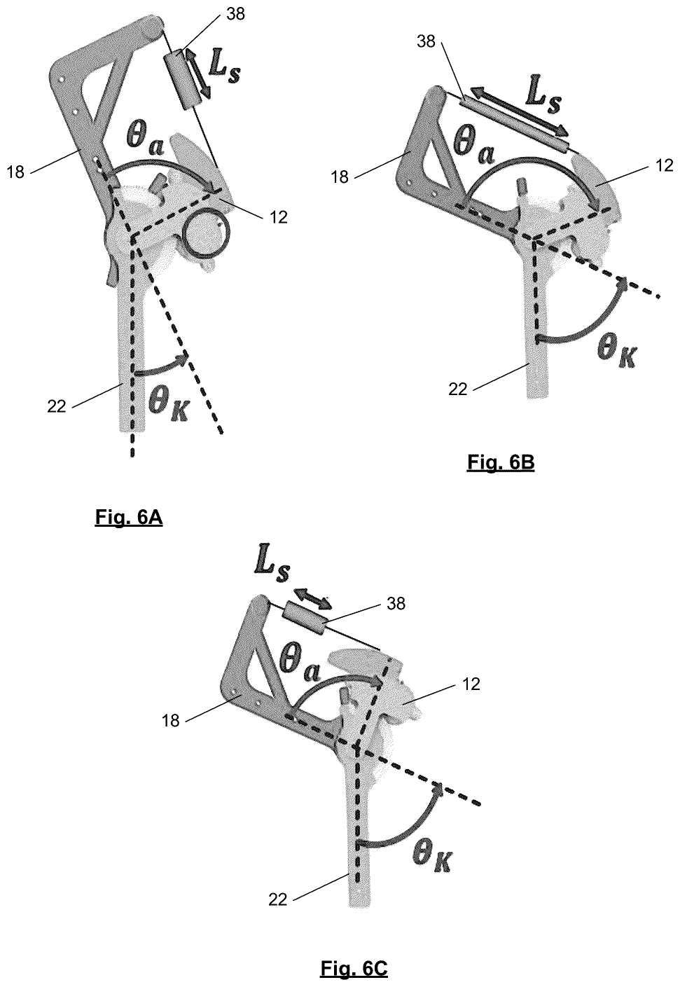

As illustrated in FIGS. 6A through 6C, the controller may be configured to operate the clutch 60 to bring it into its engaged/disengaged mode based, inter alia, on a knee angle θ_{K}, an arm-thigh link angle (i.e., the angle between the axis of the thigh link 18 and the axis of the arms 42 of the arm link 12) θₐ, a pin servo angle θₚ, and the spring length Lₛ.

According to some embodiments, when the leg is extended, for example as illustrated in FIG. 6A, θ_{K} is small, θₐ is set to 85°, the spring 38 length remains at its initial value, and θₚ can take two different angles: 50° or 85° (set by the controller). If θₚ equals 85°, the clutch 60 is brought to its engaged position, eliminating the degree of freedom between the arm link 12 and the shank link 22. In this case, as seen in FIG. 6B, knee rotation causes the arm link 12 to pivot and stretch the spring 38. When θₚ equals 50°, the clutch is in brought to is disengaged position, allowing a degree of freedom between the arm link 12 and the shank link 22. In this configuration, as illustrated in FIG. 6C, knee motion is independent of the spring 38 motion. In some embodiments, the total range of θ_{K} is about 70°, making it suitable for running and walking. According to some embodiments, the average transition time to the engaged mode may be about 79 ms, and the transition time to the disengaged mode may be about 69.5 ms.

According to some embodiments, the ratio between the motor energy input and the user's energy output saved by using the herein disclosed semi-passive knee exoskeleton assembly ranges from about 1:1 to about 1:1000 for example, from about 1:150 to about 1:1000, or from about 1:20 to about 1:1000. Each possibility is a separate embodiment.

Reverting to FIG. 1A, the semi-passive knee exoskeleton assembly 10 may comprise a computer 66, for example comprising a microcontroller, such as those provided by Arduino, constituting the controller or a main component thereof. The controller is configured, inter alia, to facilitate in decision-making, sensor visualization, timing of the engagement and disengagement of clutch 60 (e.g., based on data inputted received from an inertial measurement unit (IMU) sensor 68 mounted on the shank assembly 16. According to some embodiments, one or more sensors—e.g., including a potentiometer 70 disposed on the main knee shaft 34 configured to measure a knee angle of the user and/or the IMU sensor 68—may provide signals indicative of a user's running/walking cycle phase, a user's sitting/standing position and transitioning therebetween. According to some embodiments, the computer 66 may comprise a real-time data recording module configured to record signals received from the one or more sensors onto any suitable media, for example on a microSD card. It may further comprise a battery (e.g., a lithium polymer battery) as the power source for the components and functionalities of the exoskeleton.

As illustrated in FIG. 7, according to some embodiments, the semi-passive knee exoskeleton assembly 10 may further comprise a secondary transmission 50′, configured to support/assist a user in transitioning between sitting and standing. In particular, the secondary transmission 50′ is configured to facilitate controlling movement between the arm link 12 and the thigh link 18. It may have a similar construction to the transmission 50 described above with reference to and illustrated in FIG. 4A through 5B, mutatis mutandis, for example comprising similar elements thereto (e.g., a secondary gear train 52′, a secondary servomotor 62′, etc.), and may operate in a similar fashion, mutatis mutandis. The secondary transmission 50′ is configured to mesh with a secondary partial gear 58′ formed on a lower end of the thigh link 18.

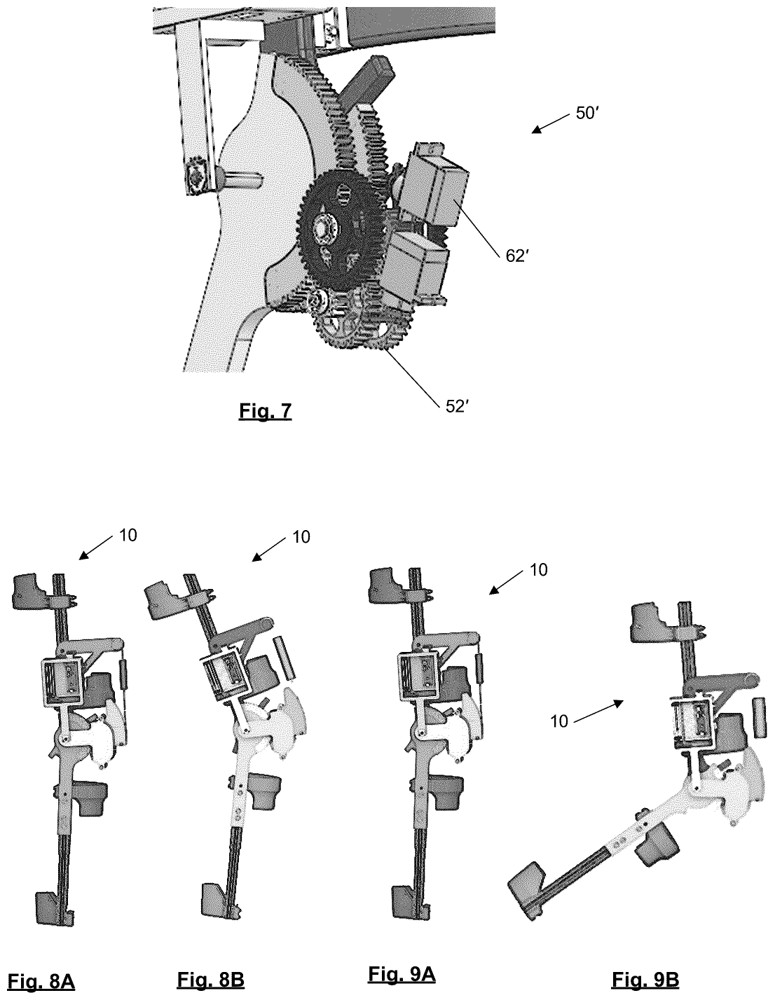

As illustrated in FIGS. 8A and 8B, during the stance phase of running/walking, the semi-passive knee exoskeleton assembly 10 may be in an engage mode knee configuration in which the clutch 60 is engaged, thereby eliminating the degree of freedom between the arm link 12 and the shank link 22, and the knee rotation causes the arm link to rotate and stretch the spring 38. According to examples in which the semi-passive knee exoskeleton assembly 10 comprises a secondary transmission 50′ for example as described above with reference to FIG. 7, the secondary clutch 60′ is disengaged and thus the arm link 12 and the thigh link 18, and thus the thigh link 18 and the spring 38, move independently of one another.

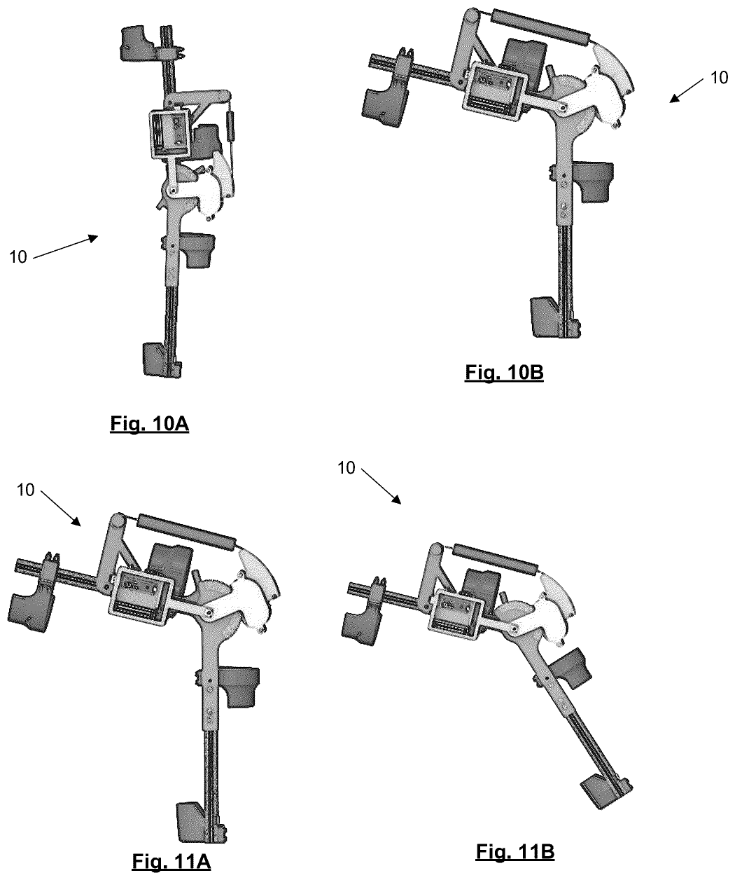

As illustrated in FIGS. 9A and 9B, in the swing phase of running/walking, the semi-passive knee exoskeleton assembly 10 may be in a disengage mode knee configuration in which the clutch 60 is disengaged, thereby providing a degree of freedom between the arm link 12 and the shank link 22. According to examples in which the semi-passive knee exoskeleton assembly 10 comprises a secondary transmission 50′ for example as described above with reference to FIG. 7, the secondary clutch 60′ is disengaged and thus knee motion is independent of the spring motion, and the arm link 12 and the thigh link 18 move independently of one another.

Furthermore, in the engaged mode, the clutch 60 is configured to facilitate causing the motion of the user's joint (e.g., a knee, an ankle) to stretch the spring 38, and in the disengaged mode, the clutch is configured to facilitate decoupling the motion of the user's joint from the spring 38.

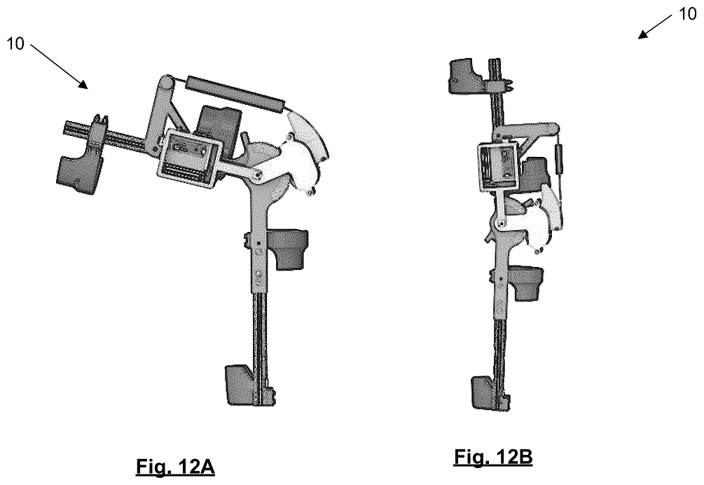

As illustrated in FIGS. 10A and 10B, when transitioning from a standing to a sitting position, the semi-passive knee exoskeleton assembly 10 transitions from a standing configuration in which the clutch 60 is disengaged, to a sitting configuration while engaging the clutch 60. During bending of the knee upon sitting, energy is extracted from the user's knee negative work and is stored as the spring 38 stretches.

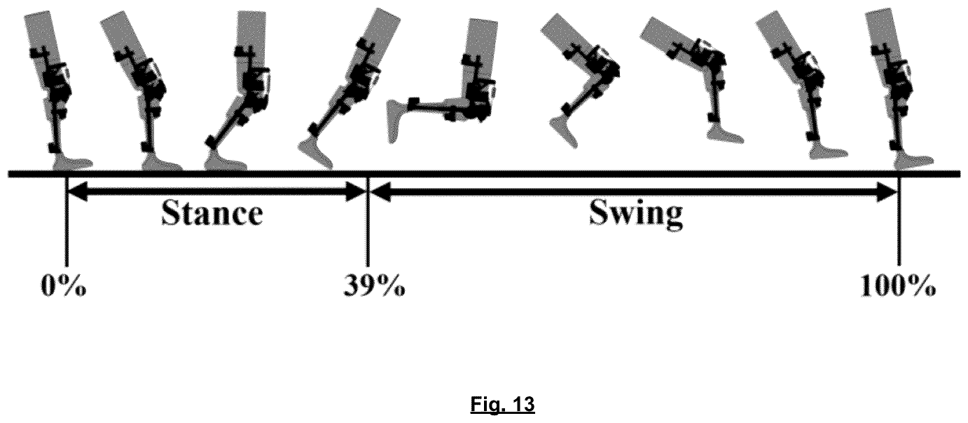

As illustrated in FIGS. 11A and 11B, according to examples in which the semi-passive knee exoskeleton assembly 10 comprises a secondary transmission 50′ for example as described above with reference to FIG. 7, upon completion of the transitioning from standing to sitting, and during sitting, the secondary clutch 60′ is engaged, eliminating the degree of freedom between the arm link 12 and the thigh link 18, thereby facilitating maintaining the spring 38 in its stretched position while the arm link 12 and the thigh link 18 are allowed to move independently of one another.

As illustrated in FIGS. 12A and 12B, when transitioning from a sitting to a standing position, the secondary clutch 60′ is disengaged, and the clutch 60 is engaged, by which energy stored in the spring 38 is transferred back to the user's knee as positive work, thereby assisting the user's muscle in transitioning from sitting to standing positions.

The controller may be configured to facilitate the transitions described above with reference to and illustrated in FIGS. 8A through 12B upon indication, e.g., based on data received from one or more sensors.

According to some embodiments, the semi-passive exoskeleton assembly 10 is capable of harnessing some of the work produced by the muscles during the negative phase, storing this energy in the spring (e.g., up to about 15%), and then returning the energy during the positive work phase (about 15% to about 39%) to assist the muscles.

As illustrated in FIG. 13, in the stance phase, the spring 38 becomes engaged, extracting energy from the knee's negative power and storing it as it stretches, and subsequently provides this stored energy as positive power to the knee. During the swing phase, the spring disengages to avoid interference with knee motion (e.g., thereby allowing free knee motion), in accordance with some embodiments. According to some embodiments, the semi-passive exoskeleton assembly 10 generates a maximum moment per single knee range from about 5 Nm to about 200 Nm. As a non-limiting example, the semi-passive exoskeleton assembly 10 may generate a maximum moment of about 28 Nm, which represents about 17% of the average full knee moment produced during running. According to some embodiments, the semi-passive exoskeleton assembly 10 may generate a maximum moment range from about 5 Nm to about 40 Nm during walking. According to some embodiments, the semi-passive exoskeleton assembly 10 may generate a maximum moment range from about 10 Nm to about 80 Nm during transitioning from sitting to standing.

### Spring Force Model

Out of the various models characterizing the behavior of viscoelastic materials encompassing a combination of springs and dampers, the Kelvin-Voigt model exhibits the most optimal fit with the least number of parameters.

The Kelvin-Voigt model can be mathematically expressed as follows:

$$σ = E ε + η \dot{ε} \qquad ( 1 )$$

where σ is the stress, E is Young's modulus, η is the damping coefficient, ε is the strain, and \dot{ε} is the strain rate. To convert stress into force:

$$F = σ A + {F}_{0} \qquad ( 2 )$$

where A is the true cross-sectional area of the rubber spring and F₀ is the initial force produced by the initial tension of the spring. Combining equations (1) and (2) yields:

$$F = ( E ε + η \dot{ε} ) \frac{{V}_{0}}{L} + {F}_{0} \qquad ( 3 )$$

where V₀ is the initial volume of the spring. L is the spring length, which depends on the angle ε and \dot{ε} are computed from the knee angle and angular velocity, respectively. The strain is:

$$ε = \frac{L}{{L}_{0}} \to \frac{r {θ}_{K}}{{L}_{0}} ; \dot{ε} = \frac{\dot{L}}{{L}_{0}} \to \frac{r {\dot{θ}}_{K}}{{L}_{0}} \qquad ( 4 )$$

where r is the distance between the spring forces to the knee joint, L₀ is the initial spring length, and θ_{K} is the change in the knee angle. Thus:

$$F = ( E \frac{r {θ}_{K}}{{L}_{0}} + η \frac{r {\dot{θ}}_{K}}{{L}_{0}} ) \frac{{V}_{0}}{{L}_{0} + r {θ}_{K}} + {F}_{0} \qquad ( 5 a )$$

$$F = ( E {θ}_{K} + η {\dot{θ}}_{K} ) \frac{{rV}_{0}}{{L}_{0} ( {L}_{0} + r {θ}_{K} )} + {F}_{0} \qquad ( 5 b )$$

In the following examples/experiments, it was found that F₀≈5 [N]. The specific values for E and η were extracted from previous experiments.

$$E = 1.588 [ MPa ] ; η = 0.016 [ MPa \cdot s ] \qquad ( 6 )$$

The moment generated at the knee by the spring can be expressed as follows:

$${Moment}_{spring} = rF \qquad ( 7 )$$

The power provided by the exoskeleton can be written as:

$${Power}_{spring} = {Moment}_{spring} {\dot{θ}}_{K} \qquad ( 8 )$$

Adding the biological moment of the muscles around the knee joint and the exoskeleton moment yields the total moment at the knee:

$${Moment}_{bio} = {Moment}_{total} - {Moment}_{spring} \qquad ( 9 )$$

Hence the biological power can be calculated as:

$${Power}_{bio} = {Power}_{total} - {Power}_{spring} \qquad ( 10 )$$

### Sample Assembly Parameters

According to some examples, the semi-passive knee exoskeleton assembly 10 may be provided wherein the mass of the clutch of the exoskeleton is about 800 g, the mass of the thigh attachment of the exoskeleton is about 450 g, the mass of the clutch of the shank attachment is about 300 g, and the mass of the control box of the exoskeleton is about 200 g, for a total of about 1650 g. According to examples, the length of the arm to the sprint is about 111 mm, the initial length of some the spring is about 55 mm, the maximum length of the spring is up to about 110 mm, the spring is made of a material having a Young's modulus of about 1.588 MPa, and the spring has a damping coefficient of about 0.016 MPa·s. According to some examples, the clutch has a maximum moment of about 28 Nm, and has a resolution of about 1° through a range of 135°.

### Sensor Output and Algorithm

According to some examples, e.g., as illustrated in FIG. 14, the controller may be configured to execute an algorithm to determine when to operate the motor 62 to engage and disengage the clutch 60, based, inter alia, from outputs of the sensors, for example the IMU sensor 68. The determination may be based, inter alia, on the angular velocity of the shank, as determined by the IMU sensor 68 (which may comprise a gyroscope to facilitate this measurement; accordingly, it is referred to in FIG. 14 using the non-limiting label “gyro x”).

The 300 ms “engage mode duration” may be selected to correspond to a typical duration of a stance phase.

The specific values relating to the timing may be determined experimentally. For example, sensors of the semi-passive knee exoskeleton assembly 10 may provide information when attached to a subject as they run, e.g., at a constant velocity of 2.25 m/s on a level surface, including, but not limited to, some or all of the IMU measurement directions relating to the leg as provided by the IMU sensor 68, the knee angle as measured by the potentiometer 70, the shank's angular velocity with respect to the world reference frame in three dimensions as measured by the IMU sensor 68, and the ankle acceleration in three dimensions for example as measured by an accelerometer sensor. For example, an experiment in which subjects ran at a constant velocity of 2.25 m/s on a level surface showed that the peak of the angular velocity occurred about 90 ms before the heel strike.

Measurements indicated that the sagittal plane velocity angle of the shank as measured by the angular velocity of the shank (in an X-direction mutually perpendicular to the axes of the shank and the foot) relative to the world frame of reference was sufficient for the control of the device. By contrast, to achieve the right timing, the gait event (foot contact and toe-off) needed to be mapped using the knee angle from the potentiometer 70 to the signal from the IMU sensor 68. The minimum of each cycle came approximately 90 ms before foot contact (clutch engaged) and 390 ms before toe-off (clutch disengaged). Therefore, control was based on identifying this point in each cycle and then applying the time delays. The algorithm may determine the minimum time required for switching to the engaged mode by reducing the minimum of each cycle by any algorithmic processing time which may be measured. The knee angle provided by the potentiometer 70 may be used to increase the accuracy in applications such as walking and running at different speeds.

### EXPERIMENTAL RESULTS

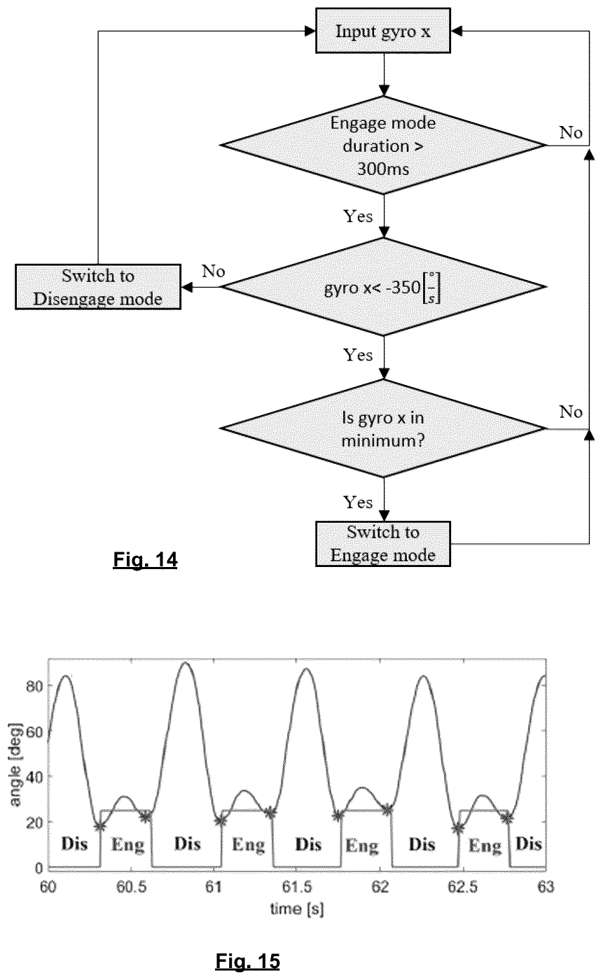

Several experiments were conducted to assess the performance of a semi-passive knee exoskeleton assembly provided as per the above. Two trials were performed to evaluate the timing of the engagement and disengagement of the clutch 60 and its effect on human users. In order to establish a control, three subjects were observed running on a level treadmill at 2.25 m/s with a video recording them at a 240 FPS. Engagement of the clutch 60 was monitored during heel strike and disengagement thereof at toe-off. As illustrated in FIG. 15, engagement (indicated by “Eng”) was determined by the elimination of the degree of freedom between the shank link 22 and the arm link 12, resulting in a substantially constant angle therebetween. Similarly, disengagement (indicated by “Dis”) was determined by the establishment of a degree of freedom between the shank link 22 and the arm link 12, leading to a change in the angle therebetween.

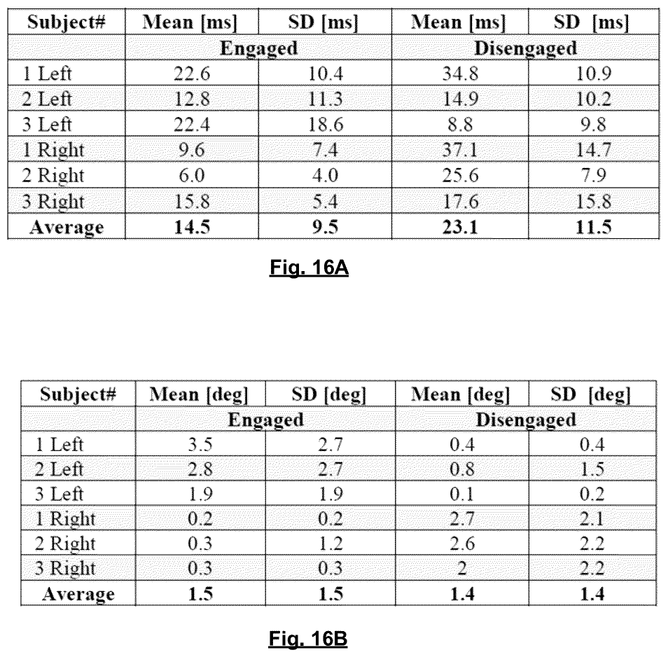

An exoskeleton as described herein was tested on three subjects, each performing 100 running cycles on each leg. The maximum average error (absolute value) was 35 ms, and the average error was 19 ms, with a standard deviation of 10.5 ms. The maximum average angular error (absolute value) was 3.5°, and the average angular error was 1.5° for all subjects (both engagement and disengagement), with a standard deviation of 1.5°. FIGS. 16A and 16B show, respectively, tabulated results of the mean time difference for engagement and disengagement from the target for all subjects, and the mean angular difference for engagement and disengagement from the target for all subjects.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

As used herein, the indefinite articles “a” and “an” mean “at least one” or “one or more” unless the context clearly dictates otherwise.

Although the disclosure is described in conjunction with specific embodiments thereof, it is evident that numerous alternatives, modifications and variations that are apparent to those skilled in the art may exist. Accordingly, the disclosure embraces all such alternatives, modifications and variations that fall within the scope of the appended claims. It is to be understood that the disclosure is not necessarily limited in its application to the details of construction and the arrangement of the components and/or methods set forth herein. Other embodiments may be practiced, and an embodiment may be carried out in various ways.

The phraseology and terminology employed herein are for descriptive purpose and should not be regarded as limiting. Citation or identification of any reference in this application shall not be construed as an admission that such reference is available as prior art to the disclosure. Section headings are used herein to case understanding of the specification and should not be construed as necessarily limiting.

As used herein, the term “about” may be used to specify a value of a quantity or parameter (e.g., the length of an element) to within a continuous range of values near (and including) a given value. According to some embodiments, “about” may specify the value of a parameter to be between 80% and 120% of the given value. According to some embodiments, “about” may specify the value of a parameter to be between 90% and 110% of the given value. According to some embodiments, “about” may specify the value of a parameter to be between 95% and 105% of the given value.

In the description and claims of the application, each of the words “comprise,” “include,” and “have,” and forms thereof, are not necessarily limited to members in a list with which the words may be associated.

In the presently disclosed subject matter, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. No feature described in the context of an embodiment is to be considered an essential feature of that embodiment, unless explicitly specified as such.

Although steps of methods according to some embodiments may be described in a specific sequence, methods of the disclosure may include some or all of the described steps carried out in a different order. A method of the disclosure may include a few of the steps described or all of the steps described. No particular step in a disclosed method is to be considered an essential step of that method, unless explicitly specified as such.

1. A semi-passive knee exoskeleton assembly configured to provide assistance to a user when running/walking, the semi-passive knee exoskeleton assembly comprising:
a thigh link associated with a thigh attachment configured to fit the user's thigh;
a shank link associated with a shank attachment configured to fit the user's shank;
an arm link pivotally articulated to the thigh link and to the shank link about a main knee shaft;
a spring connected to the thigh link at one end thereof, and to the arm link at an opposing end thereof;
a primary transmission carried within the arm link and being configured to control movement between the arm link and the shank link, the primary transmission comprising a primary clutch configured to be selectively engaged whereby the arm link pivots together with the shank link thereby engaging the shank link with the spring, and to be selectively disengaged whereby the arm link pivots independently of the shank link, the primary clutch comprising a primary motor configured to effect the engagement and disengagement;
one or more sensors, configured to provide signals indicative of the user's running/walking cycle phase; and
a controller configured to control, in real time, operation of the primary motor to engage and disengage the primary clutch;
the controller being configured, upon indication from the one or more sensors that the user has commenced a stance phase wherein the user's foot contacts the ground, to operate the primary motor to engage the clutch, such that during the bending of the knee energy is extracted from the user's knee negative power and is stored in the spring as it stretches,
the semi-passive knee exoskeleton assembly being configured to transfer energy stored in the spring to the user's knee as positive work when the user subsequently straightens the knee, thereby assisting the user's muscle in both movements, and
the controller being further configured, upon indication, from the one or more sensors that the user has commenced a swing phase, to operate the primary motor to disengage the clutch, thereby avoiding interference by the semi-passive knee exoskeleton assembly with the user's knee motion.

2. The semi-passive knee exoskeleton assembly of claim 1, wherein the thigh link is configured to convert a tensile force generated by the spring into a moment applied to a knee.

3. The semi-passive knee exoskeleton assembly of claim 1, wherein the motor is a servomotor.

4. The semi-passive knee exoskeleton assembly of claim 1, wherein the one or more sensors comprises an inertial measurement unit sensor mounted on the shank of the user, on the shank attachment, or on the shank link.

5. The semi-passive knee exoskeleton assembly of claim 1, wherein the one or more sensors comprises a potentiometer positioned on the main knee shaft and configured to measure a knee angle of the user.

6. The semi-passive knee exoskeleton assembly of claim 1, wherein the primary transmission comprises a primary gear train, one end of the primary gear train meshing with a partial gear formed on an upper end of the shank link.

7. The semi-passive knee exoskeleton assembly of claim 1, further comprising a real-time data recording module configured to record signals received from the one or more sensors.

8. The semi-passive knee exoskeleton assembly of claim 1, further comprising a computer configured to assist in decision-making and sensor visualization.

9. The semi-passive knee exoskeleton assembly of claim 1, wherein the spring is connected to the thigh link at one end thereof, and/or to the arm link at the opposing end thereof, via one or more cables.

10. The semi-passive knee exoskeleton assembly of claim 1, further comprising a stopper incorporated in the thigh link, the stopper being configured to ensure that the knee does not bend in an undesired direction.

11. The semi-passive knee exoskeleton assembly of claim 1, further comprising a control component configured to facilitate manual control over the clutch.

12. The semi-passive knee exoskeleton assembly of claim 1, wherein the ratio between the primary motor energy input and the user's energy output is between about 1:20 and about 1:1000.

13. The semi-passive knee exoskeleton assembly of claim 1, further configured to provide assistance to a user in transitioning between a sitting position and a standing position, the semi-passive knee exoskeleton assembly further comprising:
a secondary transmission carried within the arm link and being configured to control movement between the arm link the thigh link, the secondary transmission comprising a secondary clutch configured to be selectively engaged whereby the arm link pivots together with the thigh link thereby engaging the thigh link with the spring, and to be selectively disengaged whereby the arm link pivots independently of the thigh link, the secondary clutch comprising a secondary motor configured to effect the engagement and disengagement;
the controller being configured, upon indication from the one or more sensors that the user is transitioning from a standing to a sitting position, to operate the primary motor to engage the primary clutch, such that during the bending of the knee energy is extracted from the user's knee negative power and is stored in the spring as it stretches,
the controller being further configured, upon indication from the one or more sensors that the user is sitting, to operate the primary motor to disengage the primary clutch, and to operate the secondary motor to engage the secondary clutch, and
the controller being further configured, upon indication from the one or more sensors that the user has commenced transitioning from a sitting to a standing position, to operate the secondary motor to disengage the secondary clutch, and to operate the primary motor to engage the primary clutch, whereby energy stored in the spring is transferred to the user's knee as positive work, thereby assisting the user in transitioning between sitting and standing positions.

14. The semi-passive knee exoskeleton assembly of claim 16, wherein the controller is further configured, upon indication from the one or more sensors that the user is initiating a sitting position, to operate the secondary motor to engage the secondary clutch, such that during the bending of the knee energy is extracted from the user's knee negative power and is stored as the spring stretches;
the controller being further configured, upon indication from the one or more sensors that the user is in sitting position, to operate the secondary motor to engage the secondary clutch;
the controller being further configured, upon indication from the one or more sensors that the user is initiating a transition from a sitting to a standing position, to operate the secondary motor to disengage the secondary clutch, such that during straightening of the knee energy stored in the spring is transferred to the user's knee as positive work, thereby assisting the user's muscle in both movements.

15. A method for assisting running/walking of a user, the method comprising:
providing a semi-passive knee exoskeleton assembly of claim 1;
affixing the thigh and shank attachments to the user's thigh and shank, respectively;
receiving a first indication from the one or more sensors, that the user has commenced a stance phase wherein the user's foot contacts the ground;
in response to the first indication, operating the primary motor to engage the primary clutch, such that energy extracted from the user's knee negative power is stored in the spring as it stretches;
transferring energy stored in the spring as positive work when the user subsequently straightens the knee, thereby assisting the user's muscle movement; and
receiving a second indication from the one or more sensors that the user has commenced a swing phase; and
in response to the second indication, operating the primary motor to disengage the primary clutch, thereby avoiding interference by the semi-passive knee exoskeleton assembly with the user's knee motion.

16. The method of claim 15, the semi-passive knee exoskeleton assembly further comprising a secondary transmission carried within the arm link and being configured to control movement between the arm link the thigh link, the secondary transmission comprising a secondary clutch configured to facilitate selectively engaging and disengaging the thigh link, the secondary clutch comprising a secondary motor configured to effect the engagement and disengagement, the method further comprising:
receiving a third indication from the one or more sensors that the user has commenced transitioning from a standing to a sitting position;
in response to the third indication, operating the primary motor to engage the primary clutch, such that during the bending of the knee energy is extracted from the user's knee negative power and is stored in the spring as it stretches;
receiving a fourth indication from the one or more sensors that the user is sitting;
in response to the fourth indication, operating the primary motor to disengage the primary clutch, and operating the secondary motor to engage the secondary clutch;
receiving a fifth upon indication from the one or more sensors that the user has commenced transitioning from a sitting to a standing position;
in response to the fifth indication, operating the secondary motor to disengage the secondary clutch, and operating the primary motor to engage the primary clutch, whereby energy stored in the spring is transferred to the user's knee as positive work, thereby assisting the user in transitioning between sitting and standing positions.

17. A semi-passive joint exoskeleton assembly configured to provide assistance to a user to move a limb, the semi-passive joint exoskeleton assembly comprising:
a first link associated with an upper attachment configured to fit a first part of the user's limb;
a second link associated with a lower attachment configured to fit a second part of the user's limb;
an arm link pivotally articulated to the first link and to the second link about a main joint shaft;
a spring connected to the first link at one end thereof, and to the arm link at an opposing end thereof;
a transmission carried within the arm link and being configured to control movement between the arm link and the first link, the transmission comprising a clutch configured to be selectively engaged whereby the arm link pivots together with the first link, and to be selectively and to be selectively disengaged whereby the arm link pivots independently of the first link, the clutch comprising a motor configured to effect the engagement and disengagement;
one or more sensors, configured to provide signals indicative of the user's movement of the limb; and
a controller configured to control, in real time, operation of the motor to engage and disengage the clutch.
